(19) United States
(12) Patent Application Publication
(10) Pub. No.: US 2006/0002398 A1
(43) Pub. Date: Jan. 5, 2006

(54) Switching arrangement including time-slot buses and serveral buffers

(76) Inventors: Arild Wego, Lier (NO); Pal Longva Hellum, Blommenholm (NO)

Correspondence Address: ERICSSON INC., 6300 LEGACY DRIVE, M/S EVR C11, PLANO, TX, 75024, US

(21) Appl. No.: 10/526,526

(22) PCT Filed: Sep. 6, 2002
(86) PCT No.: PCT/NO02/00313

§ 371 Date: Mar. 2, 2005

(51) Int. Cl. H04L 12/28; H04L 12/56; H04L 12/54

(52) U.S. Cl. 370/395.4; 370/395.71; 370/415; 370/428

(57) ABSTRACT

An arrangement for transmitting independent serial data streams through synchronous Time Division Multiplexing (TDM) switches with a number of input and output lines is disclosed. At the receiving side of a switch, there is one data buffer per TDM bus buffering the data before transfer on the bus. A connection table associated with each buffer includes entries addressing the bytes in the buffer. The order of the addresses determines the order of the bytes as they are transferred over the bus. Also, at the transmitting side, there is one data buffer per bus, but only one common connection table. The connection table is divided into one memory area per output line, and determines the order of the data bytes, as they will occur at the respective output lines.

### FIELD OF THE INVENTION

The present invention is related to data nodes in communication networks, in particular to transmitting independent serial data streams through synchronous Time Division Multiplexing (TDM) switches.

### BACKGROUND OF THE INVENTION

The lower layer of communication networks like the connectivity layer in a core network of a cellular environment could be seen as a layer of distributed resources for managing data flows. Switches and multiplexers are some of the main components for this purpose. In complex communication networks managing data of different formats and varying data rates, it is of great importance that the construction of the components are flexible without being too complex.

Conventionally, the switches comprise a number of serial inputs and outputs. The data stream of one input may be directed in its entirety to a certain output line, or it may consist of a mixture of time division multiplexed data frames that are to be distributed to several outputs. The different lines may be running various interfaces, e.g. E1, E2; E3 and STM-1 (FIG. 1). Additionally, the data speed of each input line may vary in a wide range. The transition of data frames in the switches is often executed by means of time slot buses (TDMs) located on the back plane of the switches. A TDM bus has a total capacity in the size typically about 1 Gbit/s, where each time slot contains 64 kbit of data.

A traditional TDM-bus application consists of a data bus (usually 8 bits), a data clock and a frame synchronisation signal. The time domain is divided into frames where each frame has a fixed duration (usually 125 μs). A frame synchronisation signal indicates the start of each frame and has a period as long as the frame duration. The frame synchronisation signal and the data clock come from a synchronisation master source and form the timing master signals for all transmitters and receivers that are communicating via the TDM-bus. The frames are divided into a fixed number (n) of time slots (TS) identified by local time-slot counters. The local time-slot counters are reset by the FS signal. In each TS, data may be transmitted from a transmitter to a receiver using time division multiplexing (TDM). Serial data coming from data lines are paralleled (8 bits) so that the data can be mapped into the time slots.

In prior-art implementations of components as described above, there are limitations in the flexibility of synchronous digital switches with respect to minimum delay and configuration flexibility when combined with a non-blocking concept, multi-slot switching, high capacity and high reliability.

The international patent application WO 99/59276 describes a synchronous digital switch with improvements compared with commercial available components using switching matrix schemes with a centralised architecture.

The addressing method given in WO 99/59276 is superficially described. Using only a 2-bit RAM for each timeslot gives a limitation on how timeslots can be cross connected (switched) between two line boards. It is, for instance, not described how to change the order of the time slots.

### SUMMARY OF THE INVENTION

It is an object of the present invention to provide an arrangement that eliminates the drawbacks described above.

The features defined in the claims enclosed characterize this method.

### BRIEF DESCRIPTION OF THE DRAWINGS

In order to make the invention more readily understandable, the discussion that follows will refer to the accompanying drawings.

FIG. 1 is a block diagram illustrating an example of serial output/input lines with variable interfaces connected to a TDM bus, e.g. in a switch,

FIG. 2 shows how pointers are allocating the memory space of a TDM buffer according to the present invention,

FIG. 3 shows three different TDM buffer blocks with associated connection tables at the receiving side of three TDM buses,

FIG. 4 shows an example of an entry in a connection table at the receiving side of the TDM buses according to the present invention,

FIG. 5 shows three different TDM buffer blocks and one shared connection table at the transmitting side of three TDM buses,

FIG. 6 shows an example of an entry in a connection tables at the transmitting side of the TDM buses according to the present invention.

### DETAILED DESCRIPTION OF PREFERRED EMBODIMENTS

In the following, a preferred embodiment of the present invention will be described. This is just one of many embodiments and variations within the scope of the invention defined by the independent claims enclosed, and must not be considered as limiting.

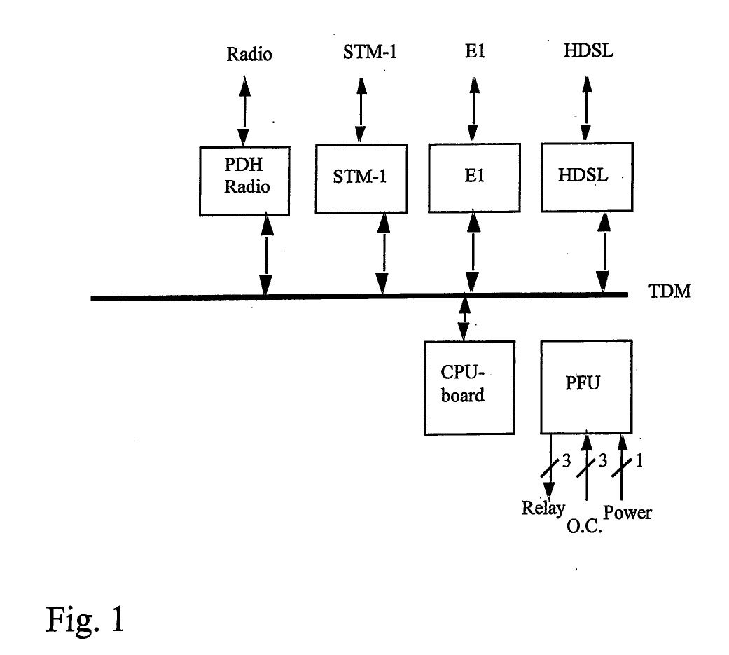

The preferred embodiment resides in a switch with I/O lines of various interfaces as shown in FIG. 1. There are three buses in the back plane, and the incoming data shall be distributed among them. There are 8192 time slots per frame available on each bus (66 MHz), which makes 24576 time slots all together.

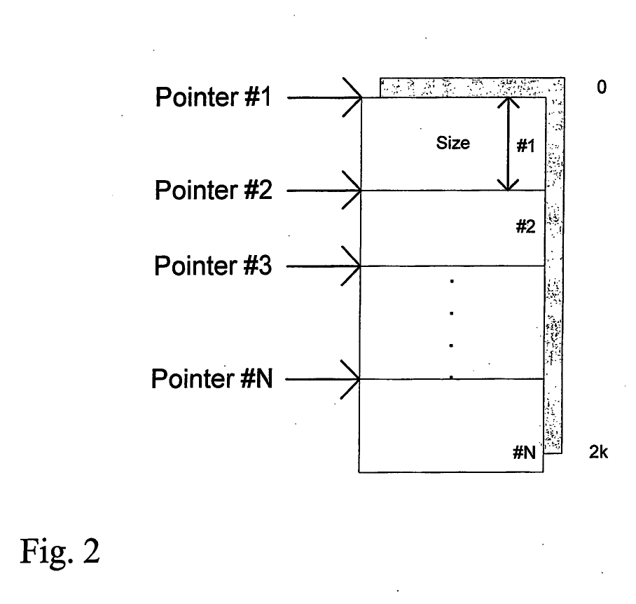

The incoming data will be buffered in one set of memory blocks for each bus. The physical size of the memory blocks is set at 2048 bytes, which means that the system can handle a maximum of 2048 different bytes (time slots) per frame. The memories are configured in advance with a pointer value for every active line as illustrated in FIG. 2.

The pointer value holds the address where the first byte in a frame is supposed to be stored. This address is loaded into a local pointer at the start of a new frame, and the pointer is incremented after data has been written to this address. The memory can be shared by 32 different lines, but can also be occupied by only one.

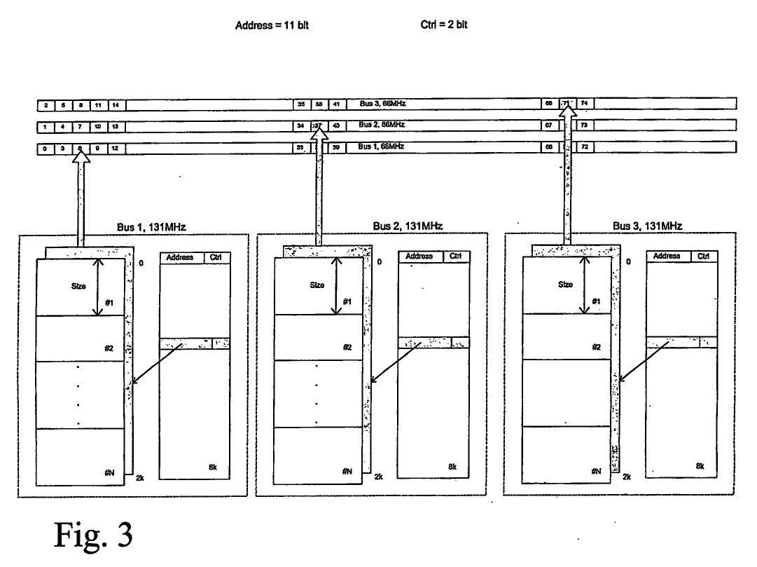

Referring to FIG. 3, in addition to the memory blocks, there is one connection table associated with each, containing 8192 entries. Each entry has one address field and one control field. The address field points to the location in the memory where the data that are to be read from the memory can be found, while the control field holds information about e.g. whether the current timeslot is enabled, whether it is a minimum delay timeslot, etc.

When reading data from the memories, a time-slot counter is used to index the connection tables. The counter is synchronized to the bus clock, and is incremented along with the time-slots in the back plane. The back plane bus can transfer three different bytes at a time (one byte per bus), so the current connection table entry will relate to timeslots x, x+1, and x+2 in parallel.

The order of the bytes with which they are placed on the bus is the same as the order of their associated addresses in the connection table. Thus, the byte sequence of the TDM buses, and hence also the switching of data from input to output lines are controlled by where the addresses are stored in the connection table. This is pre-arranged by software according to the switching requirements concerned.

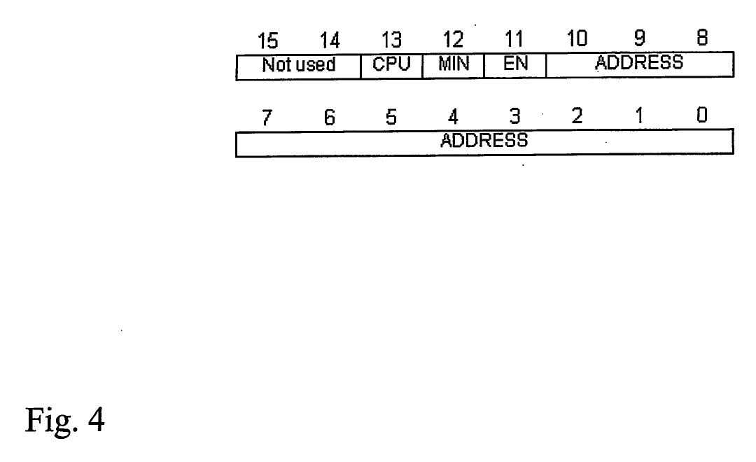

An entry in the connection table of the receiving side is shown in FIG. 4. The entry consists of the following fields:
ADDRESS addressing a byte in a memory block
EN enable time slot. Set to ‘1’ if the time slot is enabled and the corresponding data shall be put onto the back plane bus.
MIN Indicates if the timeslot is minimum delay.
CPU Indicates if data should be fetched from a CPU register

The term “minimum delay” expresses a mode of the switch in which fast data transfer is given high priority. In normal delay mode, data is stored in one frame and put on the bus in the next one. In other words, two memories are required, each containing 2048 bytes. However, in minimum delay mode, only one memory is required, since data shall be put onto the bus as fast as possible. The software programmer has to make sure that within in the same frame, a data location is not read before write-in. Minimum delay should be configured on line level and not on time-slot level.

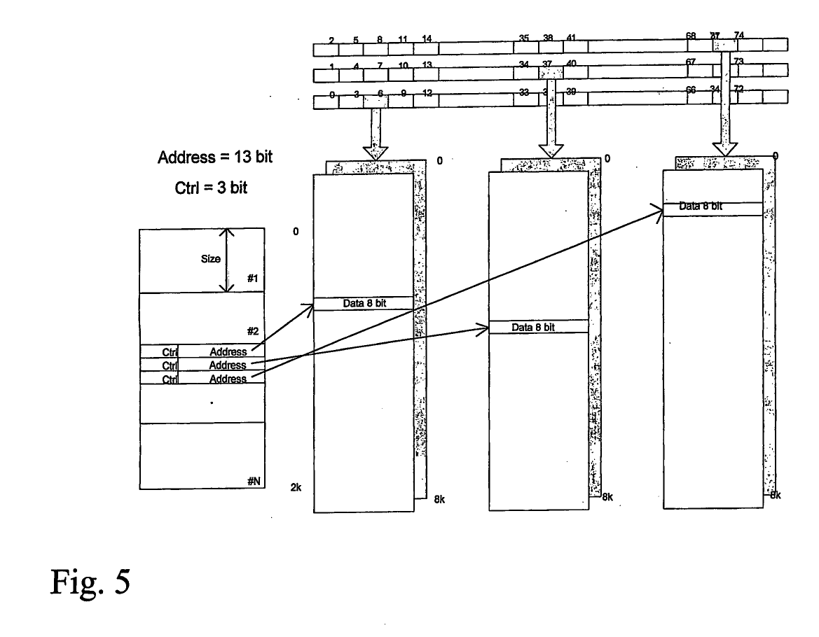

So far, only the receiving side of the TDM buses has been described. According to the present invention, a similar architecture is present at the transmitting side, as shown in FIG. 5. The modules shown are responsible for storing data coming from the back plane bus, and pass it on to the outgoing lines.

As already mentioned, there are three buses in the back plane, and each of them can have 8192 time slots (66 MHz). This makes 24576 time slots all together. The data coming from the back plane will go to one memory block per bus, and a connection table then addresses these memories. As opposed to the receiving side, there is only one connection table, and not one per bus. However, the transmitting side connection table also contains addresses and control bits. The addresses are used to point to locations in the memory blocks, while the control bits can be used to set minimum delay.

The size of the connection table is set at 2048 bytes, which means that the system can handle a maximum of 2048 different bytes per frame. The connection table is configured in advance with a size parameter and a pointer value for every active output line. The pointer value holds the address where the first memory address can be found. This pointer value is loaded into a local pointer at the start of a new frame, and the pointer is incremented after data has been fetched from the location the pointer is addressing. The connection table can be shared by 32 different lines, but can also be occupied by only one. The size parameter controls the connection table allocation.

A timeslot counter is used to index the large memory when fetching data from the back plane bus. Since there are three buses, three data bytes have to be fetched in parallel. The order of the addresses in each part of the connection table then controls the output order of the corresponding bytes in the respective output lines.

Also, at the transmitting side, minimum delay means that only one memory block per TDM bus is used, since data shall be put onto the bus as fast as possible. The software programmer has to make sure that a data location is not read before write-in within in the same frame.

32 dedicated CPU registers are available for storing idle pattern data. These patterns can be sent out on the serial lines.

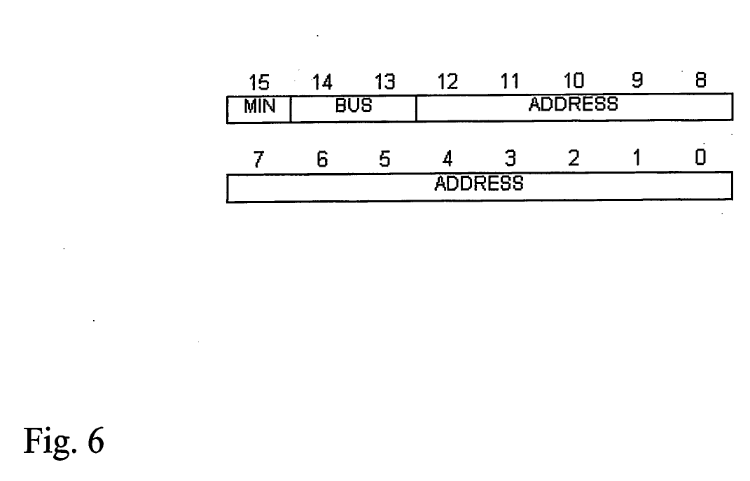

An entry in the connection table of the transmitting side is shown in FIG. 6. The entry consists the following fields:
ADDRESS the addressing of the RAM
MIN Indicates if the timeslot is minimum delay
BUS “00”—fetch data from bus 1
“01”—fetch data from bus 2
“10”—fetch data from bus 3
“11”—fetch data from a CPU register

The present invention provides full flexibility to cross connect time slots, and any combinations of time slots can be transferred between lines (changed order and number of time slots) depending on how the connection tables are configured to write to and read from the TDM bus.

Further, the delay through the node can be very low when using minimum delay. In fact, it can be less than 40 μs? for a 2 Mbit/s connection. In minimum delay mode, the system is not non-blocking.

The present invention allows for an increase in back plane speed, and high capacity can be implemented at a relatively low cost.

Also, redundant TDM bus, multicasting and broadcasting (one transmitter and several receivers) are permitted.

Abbreviation

E1 2 Mbit/s data transfer method
LINE Serial data lines, i.e. E1, STM-1 etc.
PFU Power Feeding Unit
STM-1 Synchronous Transfer Mode
TDM Time Division Multiplexing

1-9. (canceled)

10. A communication network node, said node comprising:
one or more time-slot buses operative to transfer frames from a plurality of serial input lines located on a receiving side of the node to a plurality of serial output lines located on the transmitting side of the node;
one or more data buffers at the receiving side of each time-slot bus, operative to buffer the frames from the input lines before transmission;
a connection table for each time-slot bus, wherein each entry in the connection table contains at least a data address pointing to a byte in the associated data buffer, and wherein the entries are arranged in the same order as their corresponding bytes are to be transferred on a data bus; and
a counter, synchronized to a clock used by the time-slot bus for transmission of time slots, said counter operative to indicate which byte in the associated data buffer that presently is to be read out from the data-bus buffer into a time slot in the associated data bus by indexing the entries of the connection table.

11. The communications network node recited in claim 10, wherein the data buffers are shared between all the input lines by means of respective pointers allocating one memory area in the data buffer for each of the input lines.

12. The communications network node recited in claim 10, wherein each entry in the connection table contains, in addition to the data address, a control field.

13. The communications network node recited in claim 10, wherein there is only one data buffer for each time slot bus and, within the same frame, a data location in the buffer is not read before write-in.

14. A communication network node, said node comprising:
one or more time slot buses operative to transfer frames from a plurality of serial input lines located on a receiving side of the node to a plurality of serial output lines located on the transmitting side of the node;
one or more data buffers for each time-slot bus at the transmitting side operative to buffer the frames from time-slot buses before forwarding to an output line; and,
a connection table, wherein each entry in the connection table contains at least a data address pointing to a byte in one of the data buffers, and wherein the entries are arranged in the same order as their corresponding bytes are to be transferred to an output line.

15. The communications network node recited in claim 14, wherein:
one starting pointer per output line is allocated to one memory area in the connection table for each of the output lines and points to the first entry in each memory area; and,
one indexing pointer per output line points at the entry in the connection table holding the address to the byte currently being fetched from one of the buffers to the associated output line.

16. The communications network node recited in claim 14, wherein each entry in the connection table contains, in addition to the data address, a control field.

17. The communications network node recited in claim 14, wherein there is only one data buffer for each time-slot bus and, within the same frame, a data location in the buffer is not read before write-in.

18. The communications network node recited in claim 14, wherein there is only one data buffer for each time-slot bus and, within the same frame, a data location in the buffer is not read before write-in.
